(19) United States
(12) Patent Application Publication
(10) Pub. No.: US 2009/0244491 A1
(43) Pub. Date: Oct. 1, 2009

(54) PROJECTOR AND LAMP MODULE LATERALLY EXTRACTED OUT

(75) Inventors: Chun-Ping Wang, Hsin-Chu (TW); Yung-Chuan Tseng, Hsin-Chu (TW); Shang-Hsuang Wu, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CORETRONIC CORPORATION, Hsin-Chu (TW)

(21) Appl. No.: 12/266,609

(22) Filed: Nov. 7, 2008

(30) Foreign Application Priority Data
Mar. 27, 2008 (TW) 97110969

(51) Int. Cl. G03B 21/16; F21V 29/02

(52) U.S. Cl. 353/61; 362/373

(57) ABSTRACT

A projector includes a case, an optical engine, a lamp module, and a centrifugal fan. The optical engine, the lamp module, and the centrifugal fan are disposed in the case. The case has a side cover. The lamp module is disposed adjacent to the side cover to generate heat as well as light which is modulated by the optical engine into an image light. The centrifugal fan is disposed adjacent to the lamp module, impelling air into the lamp module from a side and out from the rear to dissipate heat from the lamp module.

### CROSS REFERENCE TO RELATED APPLICATIONS

This Application claims priority of Taiwan Patent Application No. 97110969, filed on Mar. 27, 2008, the entirety of which is incorporated by reference herein.

### BACKGROUND OF THE INVENTION

1. Field of the Invention

The invention relates to a projector and a lamp module capable of being laterally extracted out of the projector for repair.

2. Description of the Related Art

Referring to FIGS. 1A and 1B, FIG. 1A is a perspective schematic diagram of a conventional projector 10 and FIG. 1B is a schematic view showing the internal structure of the projector 10 of FIG. 1A. The conventional projector 10 includes a lamp module 104 and an optical engine 105. The lamp module 104 is capable of emitting light which is modulated into image light by the optical engine 105 and the image light is adapted to be projected outside the projector 10.

In operation, the lamp module 104 generates a large quantity of heat as well as light. Accordingly, the lamp module 104 is the major heat source in the projector 10 and is required to be cooled by fans. The lamp module 104 includes a lamp cup 1044 and a lamp wick 1042, wherein the lamp cup 1044 is cooled by an axial fan 107 and the lamp wick 1042 is cooled by a centrifugal fan 108.

The lamp module 104 may break into pieces due to high temperature wear after a period of use. For repair, the top cover 102 of the projector 10 is opened to extract the lamp module 104 upward out of the projector 10. When the projector 10 is reversely hung on the ceiling for use, however, the top cover 102 of the projector 10 faces downward. Thus, the bulb fragments of the lamp module 104 may fall out and hit the repairer if the top cover 102 is opened for repairing the lamp module 104.

Referring to FIG. 2A and FIG. 2B, FIG. 2A is a schematic diagram of another conventional projector 20 and FIG. 2B is a schematic diagram showing the internal structure of the projector 20 of FIG. 2A. The conventional projector 20, similar to the above projector 10, has an axial fan 207 for cooling the lamp cup 2044 and a centrifugal fan 208 for cooling the lamp wick 2042. The lamp module 204, however, is extracted downward out of the bottom of the projector 20 for repair. When the projector 20 is reversely hung on the ceiling for use, the bottom of the projector 20 faces upward. Thus, the problem of falling bulb fragments is avoided. However, the repairer needs to detach the projector 20 from the ceiling to open the cover, thus making projector repair inconvenient.

### BRIEF SUMMARY OF THE INVENTION

An object of the invention is to provide a projector in which the lamp module is capable of being laterally extracted out, thus avoiding bulb fragments from falling out of the projector.

Another object of the invention is to provide a lamp module for a projector, in which a support board is disposed on a side of the lamp module, cool air is impelled into the lamp module from another side, and hot air is discharged from the rear of the lamp module.

A lamp module in accordance with an exemplary embodiment of the invention includes a lamp cup, a lamp wick, and a lamp holder. The lamp wick is fixed in the lamp cup. The lamp holder includes a frame and a protruding port. An interior of the frame communicates with that of the protruding port. The lamp cup is connected to the frame. The protruding port is provided with a first opening and a second opening. A first normal direction to the first opening is substantially perpendicular to a second normal direction to the second opening. Air flows into the lamp holder and the lamp cup through the first opening, and dissipates heat from the lamp wick, and flows out of the lamp holder through the second opening.

In another exemplary embodiment of the invention, the lamp module further includes a support board connected to the frame of the lamp holder, and extended substantially parallel to the second normal direction.

In yet another exemplary embodiment of the invention, the frame is provided with a third opening, and the air flows out of the lamp holder through the second opening and the third opening after dissipating heat from the lamp wick.

In another exemplary embodiment of the invention, the lamp holder further includes an air guide element communicating with the second opening and the third opening.

In yet another exemplary embodiment of the invention, the frame and the protruding port are connected as a continuous unity structure.

In another exemplary embodiment of the invention, a projector includes a case, an optical engine, the above lamp module, and a centrifugal fan. The optical engine, the lamp module, and the centrifugal fan are disposed in the case. The optical engine includes an image system and a plurality of optical elements. The case has a side cover. The lamp module is disposed adjacent to the side cover. The light emitting from the lamp module is modulated by the optical engine into an image light. The centrifugal fan is disposed adjacent to the lamp module, impelling the air into the first opening.

In yet another exemplary embodiment of the invention, the second opening faces a bottom of the projector.

In another exemplary embodiment of the invention, the optical engine further includes a mount, and the lamp holder is slidably mounted on the mount.

In yet another exemplary embodiment of the invention, the mount includes a guide groove, and the frame of the lamp holder includes a rail slidably disposed in the guide groove.

In another exemplary embodiment of the invention, the mount has an air intake communicating with the first opening.

In yet another exemplary embodiment of the invention, the mount has an air outlet communicating with the second opening.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The invention can be more fully understood by reading the subsequent detailed description and examples with references made to the accompanying drawings, wherein:

FIG. 1A is a perspective schematic diagram of a conventional projector;

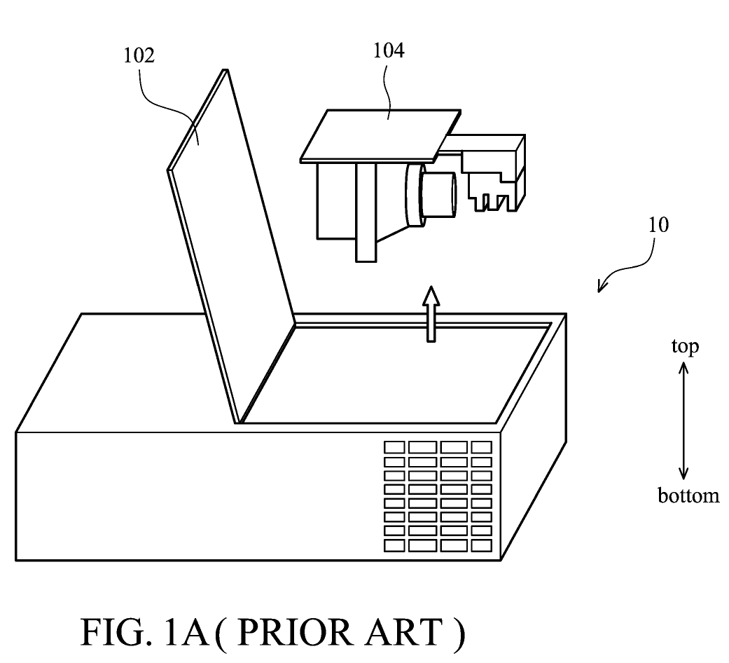

FIG. 1B is a schematic view showing the internal structure of the projector of FIG. 1A;

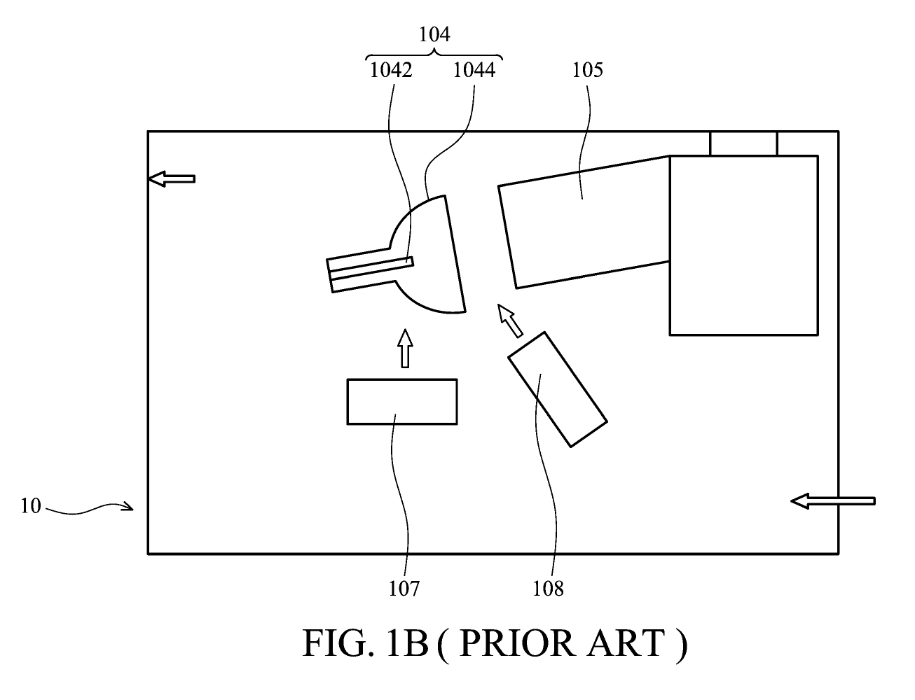

FIG. 2A is a schematic diagram of another conventional projector;

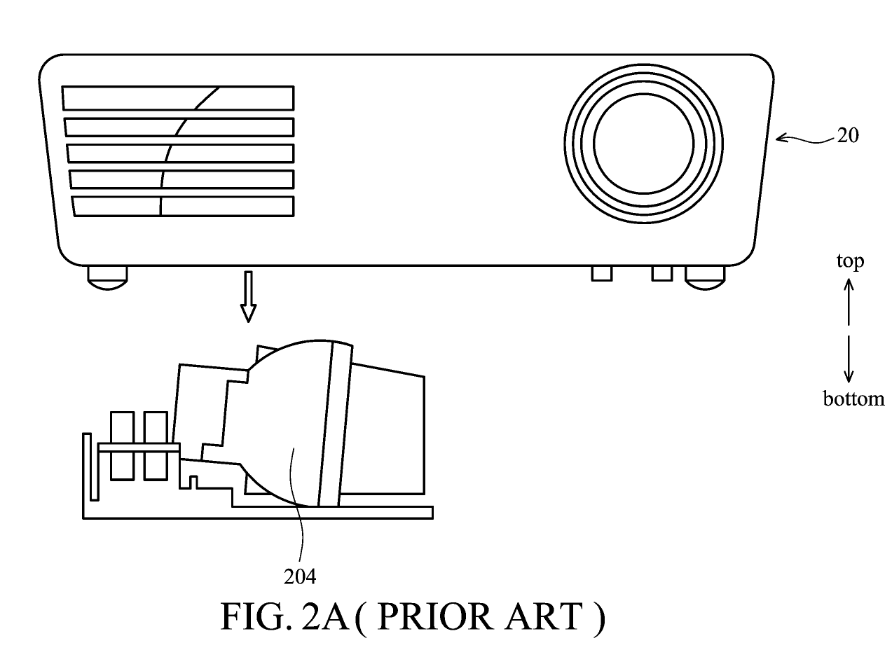

FIG. 2B is a schematic diagram showing the internal structure of the projector of FIG. 2A;

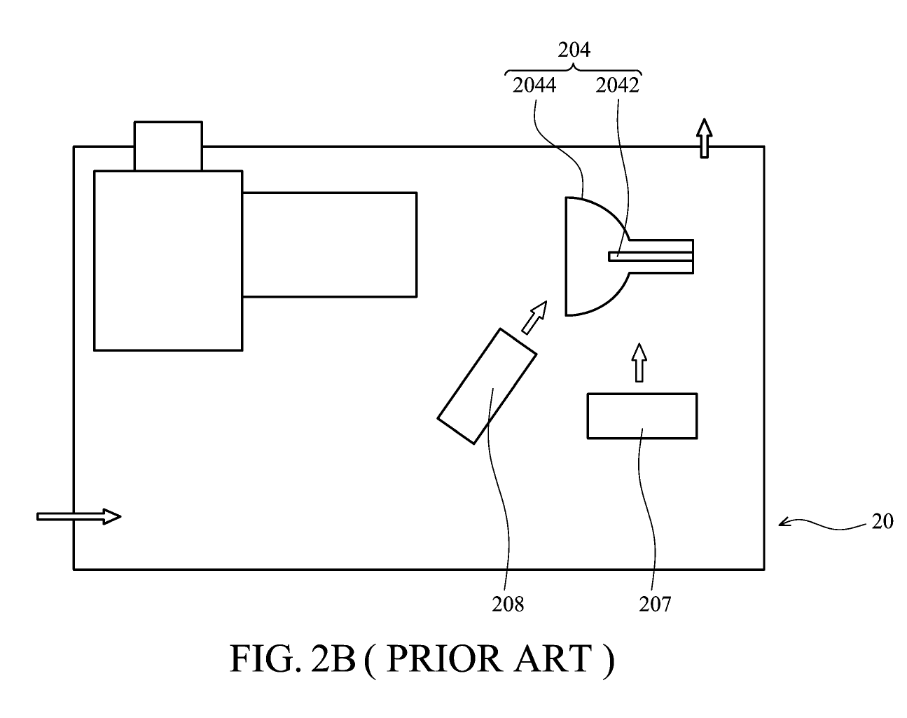

FIG. 3 is a schematic diagram showing the internal structure of a projector in accordance with an embodiment of the invention;

FIG. 4 is a perspective diagram of a lamp module and a mount of the optical engine in accordance with a first embodiment of the invention;

FIG. 5 is a perspective exploded diagram of the lamp module and the mount of the optical engine of FIG. 4;

FIG. 6 is a perspective exploded diagram with the lamp module and the mount of the optical engine of FIG. 5 reversely disposed;

FIG. 7 is a perspective diagram of a lamp module and a mount of the optical engine in accordance with a second embodiment of the invention;

FIG. 8 is a perspective exploded diagram of the lamp module and the mount of the optical engine of FIG. 7; and

FIG. 9 is a perspective exploded diagram showing the lamp module and the mount of the optical engine of FIG. 8 at a different angle.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

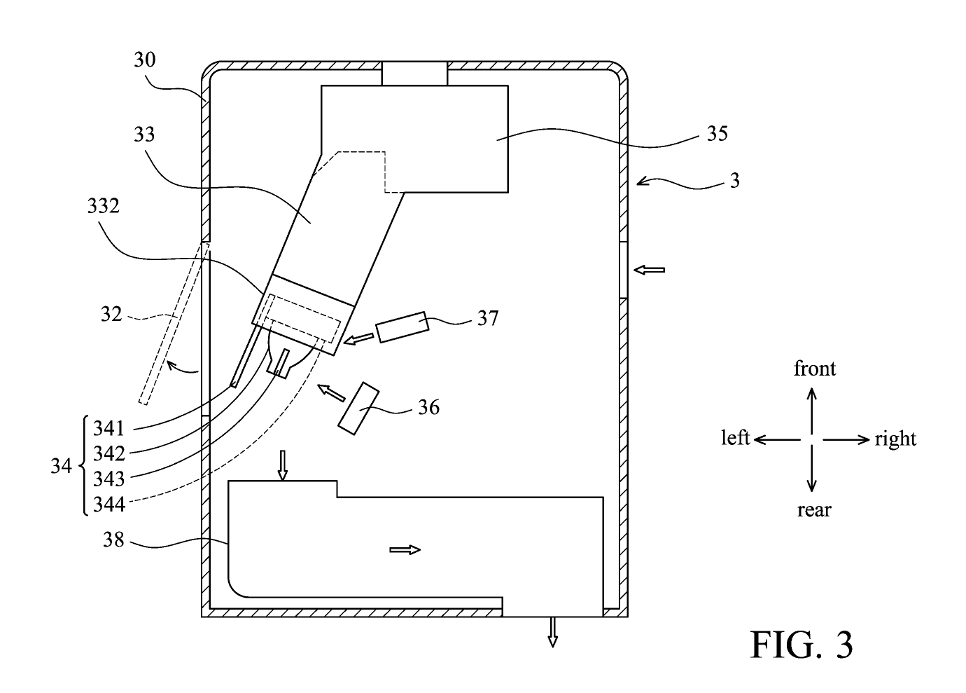

Referring to FIG. 3, FIG. 3 is a schematic diagram showing the internal structure of a projector 3 in accordance with an embodiment of the invention. The projector 3 has a case 30 in which an optical engine 33, a lamp module 34, and other elements are disposed. The lamp module 34 is capable of emitting light. The optical engine 33 includes an image system 35 and a plurality of optical elements (not shown). The light emitting from the lamp module 34 is modulated by the optical engine 33 and then the light is projected outside the projector 3.

When the projector 3 operates, the lamp module 34 generates a large quantity of heat. Therefore, an axial fan 36 and a centrifugal fan 37 are provided to dissipate the heat from the lamp module 34. Specifically, cool air entering the projector 3 is impelled to a lamp cup 342 by the axial fan 36 and to a lamp wick 343 by the centrifugal fan 37. The cool air turns into hot air by absorbing heat from the lamp cup 342 and the lamp wick 343. The structure of the lamp module 34 is designed to direct the hot air backward (described later in detail). Then, the hot air is discharged out of the projector 3 through an air duct 38.

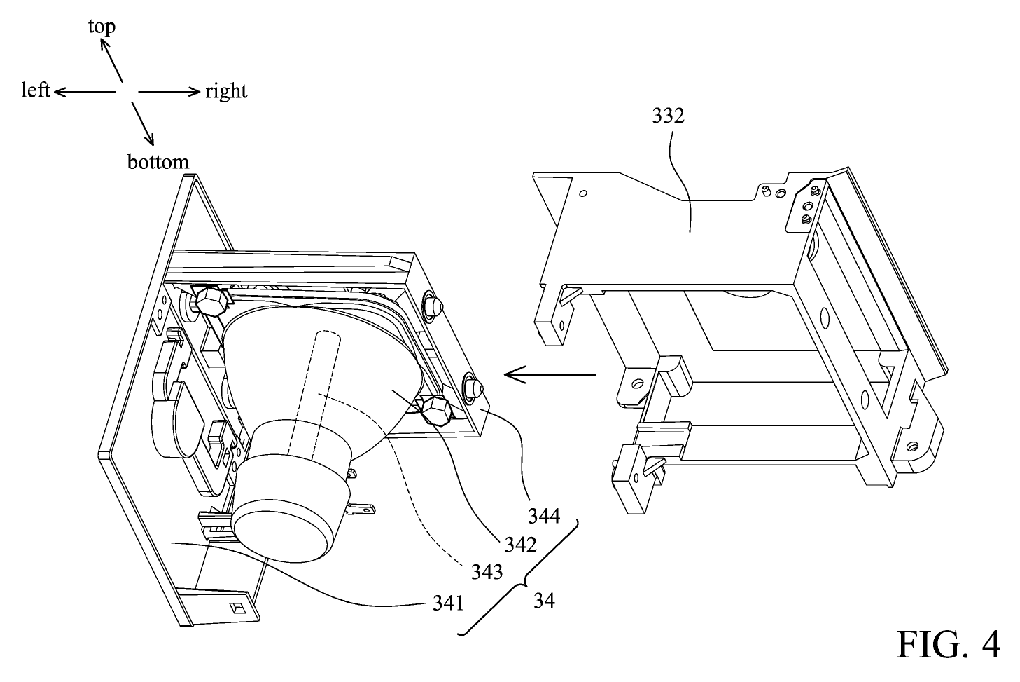

Referring to FIGS. 3 and 4, FIG. 4 is a perspective diagram of a lamp module 34 and a mount 332 of the optical engine 33 in accordance with a first embodiment of the invention, wherein the mount 332 is disposed at an end of the optical engine 33. The lamp module 34 is slidably mounted on the mount 332 and adjacent to the side cover 32 of the case 30 of the projector 3, allowing the repairer to open the side cover 32 of the case 30 and directly extract out the lamp module 34 from a side of the projector. The maintenance is very convenient. Particularly, when the projector 3 is reversely hung on the ceiling for use, the side cover 32 is laterally opened to extract out the lamp module 34, without being hindered by the ceiling, and the bulb fragments do not fall out of the projector 3.

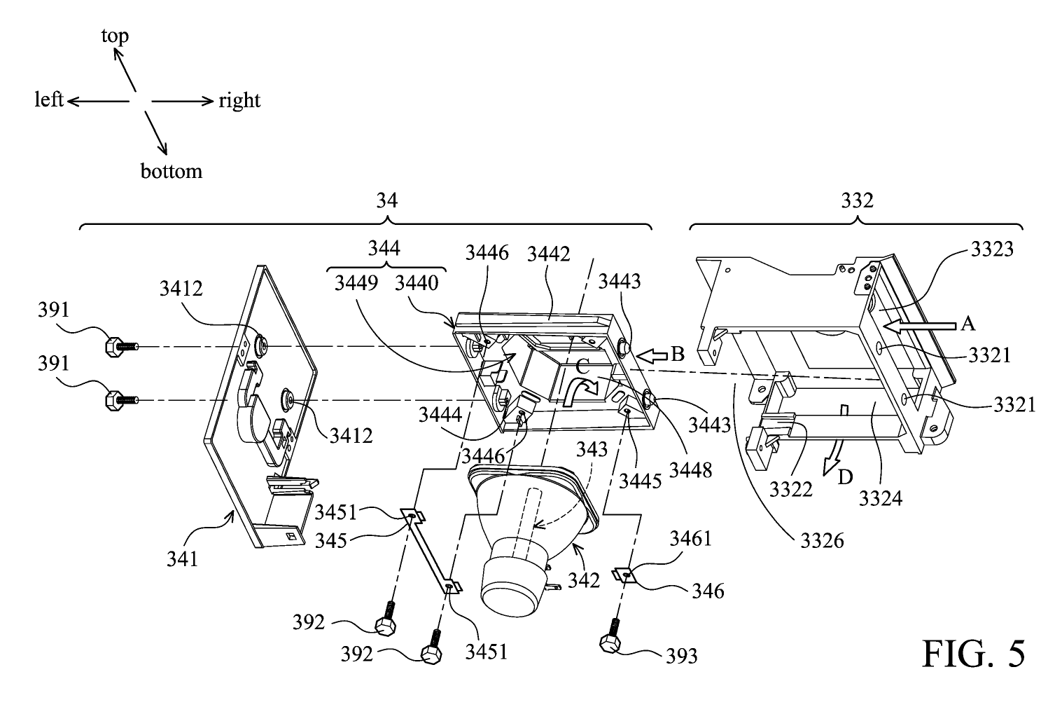

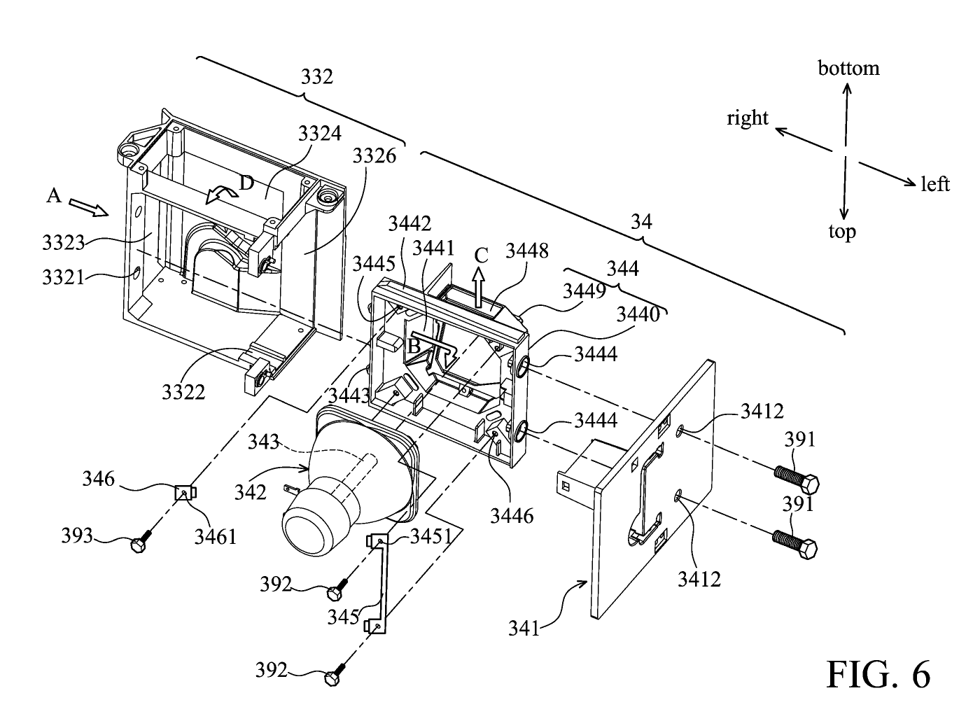

Referring to FIGS. 5 and 6, FIG. 5 is a perspective exploded diagram of the lamp module 34 and the mount 332 of the optical engine 33 of FIG. 4, while FIG. 6 is a perspective exploded diagram showing the lamp module 34 and the mount 332 of the optical engine 33 of FIG. 5 reversely disposed, wherein “top”, “bottom”, “left”, and “right” are added to clearly show the relative spatial positions of all elements. As shown, the mount 332 is provided with an entry 3326 on the left side allowing an insertion of the lamp module 34 into the mount 332. An air intake 3323 is disposed on the right side of the mount 332 to receive cool air from the centrifugal fan 37. An air outlet 3324 is disposed on the bottom of the mount 332 to discharge hot air. Also, the mount 332 is provided with a plurality of positioning holes 3321 disposed on the right side, and a guide grooves 3322 disposed on the interior of the top and bottom, respectively.

The lamp module 34 includes a lamp wick 343, a lamp cup 342, a support board 341, and a lamp holder 344, all of which are described in detail in the following:

The lamp holder 344 includes a frame 3440 and a protruding port 3449 connected the frame 3440 as a continuous-unified structure, wherein the interior of the frame 3440 communicates with the interior of the protruding port 3449. The frame 3440 is provided with a plurality of dowel pins 3443 on the right side, and rails 3442 on the top and bottom. When the lamp module 34 is mounted on the mount 332, the guide grooves 3322 of the mount 332 allow the rails 3442 to slide therein until the dowel pins 3443 are inserted into the positioning holes 3321. Referring to FIG. 6, the protruding port 3449 is provided with a first opening 3441 on the right side, and a second opening 3448 on the bottom. When the lamp module 34 is mounted on the mount 332, the first opening 3441 is connected to the air intake 3323 of the mount 332 and the second opening 3448 is connected to the air outlet 3324 of the mount 332. Furthermore, the frame 3440 is provided with a plurality of mounting holes 3444 on the left side, and a first screw opening 3446 and a second screw opening 3445 at the internal corners. The lamp wick 343 is fixed in the lamp cup 342, and the lamp cup 342 is fixed on the lamp holder 344.

In this embodiment, the left edge of the lamp cup 342 is held by a first holding element 345. A screw 392 penetrates through a first round hole 3451 of the first holding element 345 and screws into the first screw opening 3446 of the lamp holder 344. Also, the right bottom corner of the lamp cup 342 is held by a second holding element 346. A screw 393 penetrates through a second round hole 3461 of the second holding element 346 and screws into the second screw opening 3445 of the lamp holder 344. Thus, the lamp cup 342 is fixed on the lamp holder 344.

The support board 341 is fixed at the left side of the lamp holder 344. Thus, the repairer is capable of laterally opening the side cover 32 and grabbing the support board 341 to directly extract out the lamp module 34 for examination and repair. In this embodiment, the support board 341 has a plurality of through holes 3412. During assembly of the lamp module 34, screws 391 are passed through the through holes 3412 and screwed into the mounting holes 3444 to fix the support board 341 to the lamp holder 344.

In FIGS. 5 and 6, airflow is indicated by arrows A, B, C, and D. Cool air is impelled into the air intake 3323 of the mount 332 by the centrifugal fan 37 (arrow A), and enters the lamp cup 342 through the first opening 3441 of the lamp holder 344 (arrow B) to dissipate the heat from the lamp wick 343 in the lamp cup 342. Then, hot air flows downward, passes through the second opening 3448 of the lamp holder 344 (arrow C) and the air outlet 3324 of the mount 332 (arrow D), is diverted backward, and is discharged.

As described, the support board 341 is disposed on the left side of the lamp module 34. To flow away from the support board 341, hot air is guided to flow downward through the second opening 3448 , and then is diverted backward to flow out of the lamp module 34. Structurally, the first opening 3441 opens rightward and the second opening 3448 opens downward. That is, a first normal direction to the first opening 3441 is substantially perpendicular to a second normal direction to the second opening 3448. Thus, the direction in which the air flows into the first opening 3441 is substantially perpendicular to the direction in which the air flows out of the second opening 3448. Thus, the flow of the hot air (in the second normal direction) is substantially parallel to the support board 341 without being hindered by the support board 341.

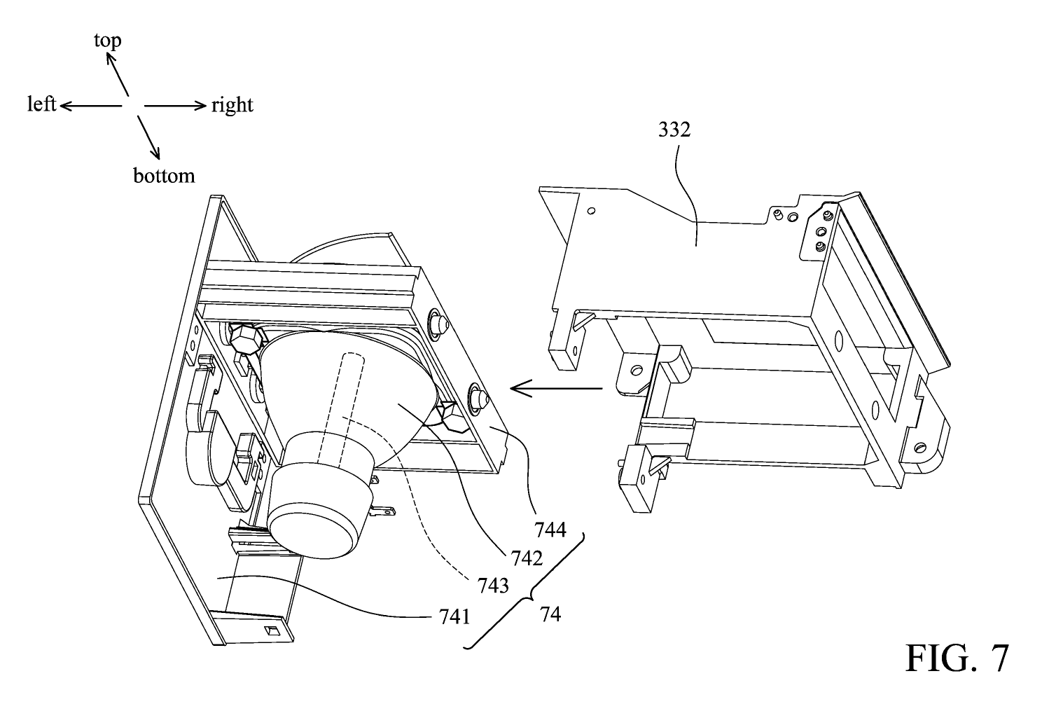

Referring to FIG. 7, FIG. 7 is a perspective diagram of a lamp module 74 and a mount 332 of the optical engine in accordance with a second embodiment of the invention, wherein the mount 332 is identical to that of the first embodiment. Therefore, the descriptions of the mount 332 are omitted. Similar to the first embodiment, the lamp module 74 is slidably mounted on the mount 332 and is laterally extracted from a side of the lamp module 74 by the repairer, without the problems of being hindered by the ceiling and falling of the bulb fragments.

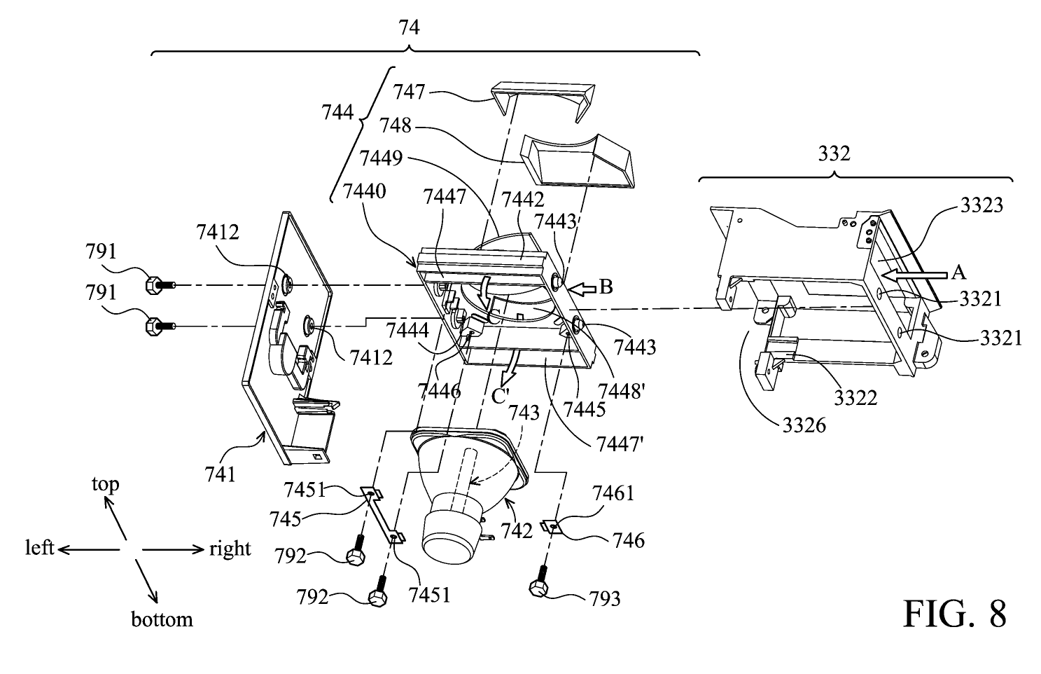

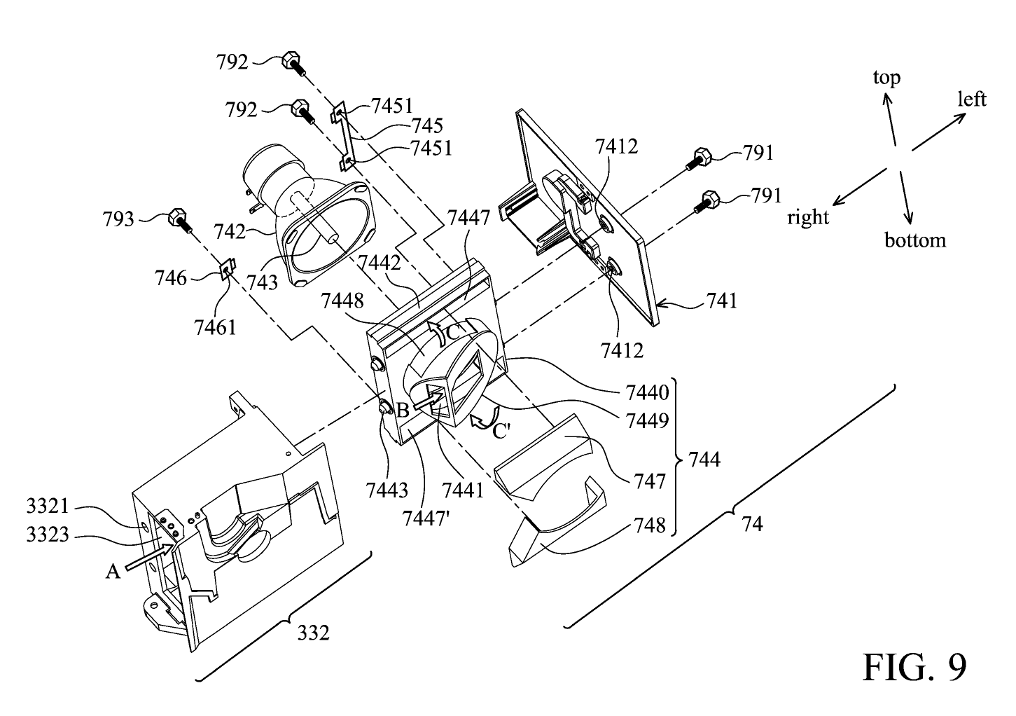

Referring to FIGS. 8 and 9, FIG. 8 is a perspective exploded diagram of the lamp module 74 and the mount 332 of the optical engine of FIG. 7, and FIG. 9 is a perspective exploded diagram showing the lamp module 74 and the mount 332 of the optical engine of FIG. 8 at a different visual angle, wherein “top”, “bottom”, “left”, and “right” are added to clearly show the relative spatial positions of all elements. As shown, the lamp module 74 includes a lamp wick 743, a lamp cup 742, a support board 741, and a lamp holder 744, all of which are described in detail in the following:

The lamp holder 744 includes a frame 7440, a protruding port 7449, and two air guide elements 747 and 748. The frame 7440 and the protruding port 7449 are connected the frame 7440 as a continuous-unified structure, wherein the interior of the frame 7440 communicates with the interior of the protruding port 7449. The frame 7440 is provided with a plurality of dowel pins 7443 on the right side, and rails 7442 on the top and bottom. When the lamp module 74 is mounted on the mount 332, the guide grooves 3322 of the mount 332 allow the rails 7442 to slide therein until the dowel pins 7443 are inserted into the positioning holes 3321. Referring to FIG. 9, the protruding port 7449 is provided with a first opening 7441 on the right side. When the lamp module 74 is mounted on the mount 332, the first opening 7441 is connected to the air intake 3323 of the mount 332. Furthermore, second openings 7448 (FIG. 9) and 7448′ (FIG. 8) are respectively provided on the top and bottom of the protruding port 7449, and third openings 7447 and 7447′ are respectively disposed on the top and bottom of the frame 7440. The air guide element 747 connects the second opening 7448 with the third opening 7447, while the air guide element 748 communicates the second opening 7448′ and the third opening 7447′. The air guide elements 747 and 748 may be screwed on, glued to, or integrally formed with the frame 7440. Referring to FIG. 8, the frame 7440 is provided with a plurality of mounting holes 7444 on the left side, and a first screw opening 7446 and a second screw opening 7445 at the internal corners. The lamp wick 743 is fixed in the lamp cup 742, and the lamp cup 742 is fixed on the lamp holder 744.

In this embodiment, the left edge of the lamp cup 742 is held by a first holding element 745, with a screw 792 penetrating through a first round hole 7451 of the first holding element 745 into the first screw opening 7446 of the lamp holder 744. Also, the right bottom corner of the lamp cup 742 is held by a second holding element 746, with a screw 793 penetrating through a second round hole 7461 of the second holding element 746 into the second screw opening 7445 of the lamp holder 744. Thus, the lamp cup 742 is fixed on the lamp holder 744.

The support board 741 is fixed on the left side of the lamp holder 744. Thus, the repairer is capable of laterally opening the side cover 32 of the projector 3 and grabbing the support board 341 to directly extract out the lamp module 74 for examination and repair. In this embodiment, the support board 741 has a plurality of through holes 7412. During assembly of the lamp module 74, screws 791 are passed through the through holes 7412 and screwed into the mounting holes 7444 of the lamp holder 744 to fix the support board 741 to the lamp holder 744.

In FIGS. 8 and 9, airflow is indicated by arrows A, B, C, and C′. Cool air is impelled into the air intake 3323 of the mount 332 by the centrifugal fan 37 (arrow A), and flows into the lamp cup 742 through the first through hole 7441 of the lamp holder 744 (arrow B) to dissipate the heat from the lamp wick 743 in the lamp cup 742. Then, hot air is separated and flows in two paths. In the first path, hot air flows upward, passes through the second opening 7448 of the lamp holder 744 (arrow C), is guided by the air guide element 747 to be diverted backward, and is discharged out of the third opening 7447. In the second path, hot air flows downward, passes through the second opening 7448′ of the lamp holder 744 (arrow C′), is guided by the air guide element 748 to be diverted backward, and is discharged out of the third opening 7447′.

As described, the support board 741 is disposed on the left side of the lamp module 74. To flow away from the support board 741, hot air is guided to flow upward and downward to flow through the second openings 7448 and 7448′, and then is diverted backward to flow out of the lamp module 74. Structurally, the first opening 7441 opens rightward (in a first normal direction), the second opening 7448 opens upward (a second normal direction), and the second opening 7448′ opens downward (in a third normal direction). That is, the first normal direction to the first opening 7441 is substantially perpendicular to the second and third normal directions to the second openings 7448 and 7448′. Thus, the direction in which the air flows into the first opening 7441 is substantially perpendicular to the direction in which the air flows out of the second openings 7448 and 7448′. Thus, the flow direction of the hot air (in the second and third normal directions) is substantially parallel to the support board 741 and is not hindered by the support board 741.

In the second embodiment, hot air is separated and flows through the second openings 7448 and 7448′ in two paths. Such an arrangement, however, is capable of being modified. For example, one of the second openings 7448 and 7448′ of the lamp holder 744 is sealed so that hot air is capable of flowing in the other path to be discharged out of the lamp module 74.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lamp module, comprising:
a lamp cup;
3 a lamp wick fixed in the lamp cup; and
a lamp holder including a frame and a protruding port, wherein an interior of the frame communicates with an interior of the protruding port, the lamp cup is connected to the frame, the protruding port is provided with a first opening and a second opening, a first normal direction to the first opening is substantially perpendicular to a second normal direction to the second opening, and air flows into the lamp holder and the lamp cup through the first opening and dissipates heat from the lamp wick and flows out of the lamp holder through the second opening.

2. The lamp module as claimed in claim 1, further comprising a support board connected to the frame of the lamp holder, and extended substantially parallel to the second normal direction.

3. The lamp module as claimed in claim 1, wherein the frame is provided with a third opening, and the air flows out of the lamp holder through the second opening and the third opening after dissipating the heat from the lamp wick.

4. The lamp module as claimed in claim 1, wherein the lamp holder further comprises an air guide element communicating with the second opening and the third opening.

5. The lamp module as claimed in claim 1, wherein the frame and the protruding port are connected as a continuous unity structure.

6. A projector, comprising:
a case comprising a side cover;
an optical engine comprising an image system and a plurality of optical elements disposed in the case;
a lamp module as claimed in claim 1, disposed in the case and adjacent to the side cover, being capable of emitting light which is modulated by the optical engine into an image light; and
a centrifugal fan, disposed in the case and adjacent to the lamp module, impelling the air into the first opening.

7. The projector as claimed in claim 6, wherein the second opening faces a bottom of the projector.

8. The projector as claimed in claim 6, wherein the optical engine further comprises a mount, and the lamp holder is slidably mounted on the mount.

9. The projector as claimed in claim 8, wherein the mount comprises a guide groove, and the frame of the lamp holder comprises a rail slidably disposed in the guide groove.

10. The projector as claimed in claim 8, wherein the mount has an air intake communicating with the first opening.

11. The projector as claimed in claim 8, wherein the mount has an air outlet communicating with the second opening.
